(19) United States
(12) Patent Application Publication
(10) Pub. No.: US 2004/0218843 A1
(43) Pub. Date: Nov. 4, 2004

(54) Radial bearing unit for a driveshaft

(75) Inventors: Peter Jennes, Koln (DE); Uwe Abraham, Recklinghausen (DE); Pierre Simon, Haguenau (FR)

Correspondence Address: HENRY M FEIEREISEN, LLC, 350 FIFTH AVENUE, SUITE 4714, NEW YORK, NY, 10118, US

(73) Assignee: INA-SCHAEFFLER KG, Herzogenaurach (DE)

(21) Appl. No.: 10/763,823

(22) Filed: Jan. 22, 2004

Related U.S. Application Data
(63) Continuation of application No. PCT/EP02/07977, filed on Jul. 18, 2002.

(30) Foreign Application Priority Data
Jul. 27, 2001 (DE) 101 36 127.0

(51) Int. Cl. F16C 23/04

(52) U.S. Cl. 384/498

(57) ABSTRACT

A radial bearing unit for a driveshaft in motor vehicles, in particular a halfshaft for connecting a transmission with a driven front wheel, includes a holder having a housing made of two housing portions which are so configured as to form together a spherical receptacle. The integrity of the housing is realized by providing the housing portions with flanges for mutual support. Seated in the spherical receptacle is a curved outer surface area of a rolling-contact bearing. Each of the housing portions has at least two tabs extending radially in spaced-apart relationship from the flanges for form-fitting engagement in a machine part, when the radial bearing unit is installed in the machine part.

### CROSS-REFERENCES TO RELATED APPLICATIONS

This application is a continuation of prior filed copending PCT International application No. PCT/EP02/07977, filed Jul. 18, 2002, which designated the United States and on which priority is claimed under 35 U.S.C. §120, the disclosure of which is hereby incorporated by reference.

This application claims the priority of German Patent Application, Serial No. 101 36 127.0, filed Jul. 27, 2001, pursuant to 35 U.S.C. 119(a)-(d), the disclosure of which is incorporated herein by reference.

### BACKGROUND OF THE INVENTION

The present invention relates to a radial bearing unit for a driveshaft arranged in a motor vehicle, in particular for a drive halfshaft for connecting the transmission with a driven front wheel in motor vehicle front drive.

Motor vehicles of this type are provided with an internal combustion engine, which is installed transversely to the traveling direction, and include cardan shafts of different lengths. The cardan shaft of greatest length is provided with a drive halfshaft for implementation of same diffraction angles for the drive joints. The halfshaft is hereby provided with a radial bearing unit, which includes a rolling-contact bearing and a holder for placement of the rolling-contact bearing in a machine part, and is mounted in particular to the crankcase of the internal combustion engine. The rolling-contact bearing is formed hereby with a curved outer surface area which is seated in a complementary spherical receiving surface of the holder. As a result, the rolling-contact bearing is able to self-adjust during installation in relation to the holder to thereby compensate manufacturing tolerances for example.

U.S. Pat. No. 6,132,099 to Olszewski et al. describes a radial bearing unit which is received by a holder mounted to the motor block. The radial bearing unit has an inner ring which is secured in fixed rotative engagement on the halfshaft. The halfshaft has a cardan joint immediately at the transmission output, thereby eliminating the need for alignment of the radial bearing unit. The arrangement of a further cardan joint raises, however, the number of components and complicates the assembly, thereby increasing the costs for the halfshaft.

A radial bearing unit is further described in the workshop repair manual (Manual de Reparation N. 8881) for the vehicle Citroën BX, edition of September 1982, chapter 5, page 3. The figure XB 16 illustrates a holder which appears to be mounted on the engine block and supports the drive shaft, with the outer ring of a radial bearing unit being restrained in the holder against rotation. Secured to the drive halfshaft is the inner ring which is supported by a shoulder that forms an axial stop of the radial bearing unit. This conventional radial bearing unit assembly does not allow a self-alignment, i.e. no compensation for a radial offset between the radial bearing unit and the drive halfshaft during installation.

International publication no WO 97/43138 discloses a radial bearing unit for a drive halfshaft, having two housing portions in which a rolling-contact bearing with a curved peripheral surface area is seated in a spherical receptacle of the housing portions. This configuration of the holder allows an alignment of the radial bearing unit in relation to the halfshaft during installation. Securement of the radial bearing unit upon the machine part is realized by bolting, whereby flanges connected in one piece with the housing portions are disposed in surrounded relationship to the rolling-contact bearing and formed with bores via which the holder is bolted to the machine part.

It would be desirable and advantageous to provide an improved radial bearing unit to obviate prior art shortcomings and to simplify installation in a machine part.

### SUMMARY OF THE INVENTION

According to one aspect of the present invention, a radial bearing unit for a driveshaft in a motor vehicle, in particular a halfshaft for connecting a transmission with a driven front wheel, includes a holder having a housing comprised of two housing portions which are so configured as to form together a spherical receptacle, with each of the housing portions having a flange for mutual support of the housing portions, and a rolling-contact bearing having a curved outer surface area for seating in the spherical receptacle, wherein each of the housing portions has at least two radial tabs extending radially in spaced-apart relationship from the flanges for form-fitting engagement in a machine part, when the radial bearing unit is installed in the machine part.

According to another aspect of the present invention, a radial bearing unit for a driveshaft in a motor vehicle, in particular a halfshaft for connecting a transmission with a driven front wheel, includes a rolling-contact bearing having a curved surface area, a housing portion forming with a machine part a spherical receptacle for accommodating the rolling-contact bearing, a radial flange disposed in outer surrounding relationship to the housing portion and formed with at least two radial tabs for form-fitting securement to the machine part, when the radial bearing unit is installed in the machine part. This type of radial bearing unit self-adjusts during assembly and has a minimum number of components for support of the halfshaft. Thus, assembly is easy and costs for the bearing unit are reduced. Suitably, the spherical receptacle in the machine part and the housing portion is so configured that half of the rolling-contact bearing is supported by the machine part and the other half by the housing portion.

Regardless of the configuration of a radial bearing unit in accordance with the present invention, the assembly is simplified because in either embodiment the radial bearing unit including rolling-contact bearing and holder or housing portion can be installed in the machine part in an automated manner. This is cost-efficient in particular when large-scale production is involved.

According to another feature of the present invention, the machine part may be formed with axial recesses that each extend inwards from an end surface of the machine part to an annular groove for receiving the holder in the machine part. Position, size and number of axial recesses in the machine part are hereby suited to the disposition of the tabs on the housing portions of the holder.

Suitably, the radial bearing unit is installed by first pushing the holder via the axial recesses into the machine part until entering their annular groove, and then twisting the holder with integrated rolling-contact bearing in the annular grooves until the tabs fully overlap one another. Each annular groove is hereby provided in the machine part in such a way that the rotation direction of the holder relative to the machine part corresponds during installation to the rotation direction of the driveshaft during travel of the motor vehicle. As a result, the rotation direction of the drive shaft is prevented from triggering a momentum that could lead to a loosening of the holder in the machine part.

According to another feature of the present invention, the holder can be turned by a tool until striking against an end stop of the groove in the machine part. The tool engages hereby one of the housing portions and may be configured as a dog spanner or a shaft nut wrench which may form-fittingly engage indentations of the one housing portion or interact with axial protrusions to rotate the holder with the integrated rolling-contact bearing to the end stop.

In order to automatically secure or fix the holder in place, the annular groove may have a tapered configuration. Suitably, the annular groove narrows from the axial recess in the machine part continuously along the entire length thereof in the direction to the end stop. In this way, a desired wedging action is realized to effect a permanent securement of the tabs in the machine part. As an alternative, it is also conceivable to secure the tabs in the machine part by a snap-fit or clipped connection. For example, the tabs of the holder may latch onto a safety member provided in circumferential direction of the annular groove. The safety member may be a snap nose which projects axially into the annular groove for engagement, e.g., in a complementary projection of the tab. Another option includes the provision of axially projecting protrusions or lugs from one or more tabs for engagement in a, preferably radial, groove or depression of the annular groove.

The securement may also be implemented by providing an elastically biased axial or radial retaining lug which is formed on at least one of the tabs of the housing portion. The retaining lug is so configured as to lock in end position in the area of the annular groove at or in a respective recess of the machine part. This securement results in a permanent connection between the holder and the machine part, regardless of the rotation direction.

According to another feature of the present invention, the holder may be mounted to the machine part by a type of bayonet coupling, with the holder being secured to the machine part by two radial fastening screws.

Another embodiment for realizing an effective securement of the holder or a housing portion involves a threaded connection. Hereby, the flanges are provided at the outer circumference with an external thread for form-fitting engagement with an internal thread of the machine part in the area of the axial recess. In order to increase the number of thread turns, the tabs may be formed in one piece with arms extending at a right angle. Suitably, a housing portion is provided with several arms that are symmetrically spaced about the circumference and have an external thread for threaded engagement in an internal thread of the machine part, when the holder is rotated. The thread has suitably a large pitch and is so configured that the holder or the housing portion rests against a contact surface of the machine part after rotating the holder about a defined angle.

According to another feature of the present invention, the arm may have a free end which may be formed with a radially-biased snap nose for form-fitting engagement in a pocket of the machine part, when the arm reaches an end position. In this way, the holder or the housing portion is fixedly secured in the end position in relation to the machine part, whereby this fixed securement can be released only through intervention of a particular tool.

As an alternative, or in addition to the afore-described securing measures, it is also possible to secure the holder at the machine part by pins or bolts. Pinning or bolting may, for example, be implemented once the bores in the machine part and the tabs are aligned. Furthermore, the holder may be effectively secured in an end position by swaging peripheral zones of the annular groove in the machine part.

Assembly may be simplified by securing the housing portions of the holder after incorporation of the rolling-contact bearing relative to one another. This may be realized by a clipped connection to establish a captivated pre-fabricated unitary structure.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic illustration of a typical arrangement of halfshafts between a transmission and driven front wheels of a motor vehicle;

FIG. 2 is a partially sectional view of one embodiment of a radial bearing unit according to the present invention integrated in a machine part;

FIG. 3 is a front view of a holder of the radial bearing unit;

FIG. 4 is a longitudinal section of the radial bearing unit with holder and integrated rolling-contact bearing;

FIG. 4a is a detailed cutaway view of the radial bearing unit of FIG. 4 with clipped connection for effecting integrity of the holder;

FIG. 4b is a detailed cutaway view of a variation of the radial bearing unit of FIG. 4 for connecting a housing portion to the machine part;

FIG. 5 is a fragmentary longitudinal section of the machine part, on an enlarged scale, showing in detail an annular groove and an axial recess in the machine part;

FIG. 6 is a fragmentary longitudinal section of the machine part, on an enlarged scale, showing in detail a tapered annular groove and an axial recess in the machine part;

FIG. 7a is a cutaway view of the machine part, showing a first variation of a securing mechanism for a tab in the annular groove;

FIG. 7b is a partly sectional detailed view of the machine part as viewed in the direction of arrow X in FIG. 7a;

FIG. 8a is a cutaway view of the machine part, showing a second variation of a securing mechanism for a tab in the annular groove;

FIG. 8b is a partly sectional detailed view of the machine part as viewed in the direction of arrow Y in FIG. 8a;

FIG. 9a is a half section of a housing portion of the holder, showing a tab with resilient retaining lug;

FIG. 9b is an enlarged detailed view of the annular groove in the machine part for guidance and securement of the tab of FIG. 9a;

FIG. 10a is a cutaway view of a holder, showing a tab with external thread for threaded connection with the machine part;

FIG. 10b is an enlarged detailed view of the holder as viewed in the direction Z in FIG. 10a; and

FIG. 11 is a sectional view of another embodiment of a radial bearing unit according to the present invention.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

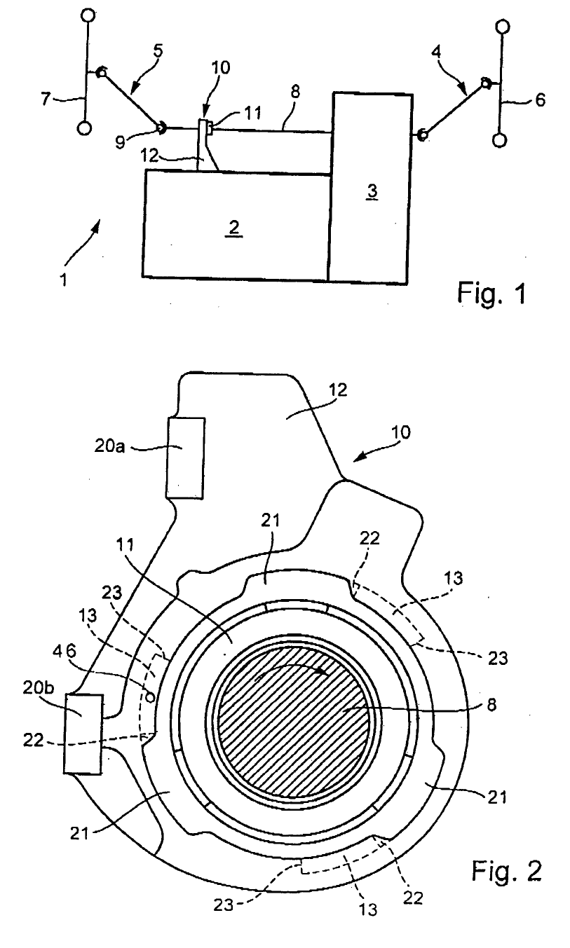

Turning now to the drawing, and in particular to FIG. 1, there is shown a schematic illustration of a general configuration of a drive unit for a motor vehicle, generally designated by reference numeral 1 and defining a longitudinal axis which runs perpendicular to the plane of the drawing paper in FIG. 1. The drive unit 1 includes an internal combustion engine 2 and a transmission 3 and is connected via cardan shafts 4, 5 with the driven front wheels 6, 7 of the motor vehicle. As a consequence of the off-center disposition of the transmission 3 to the longitudinal vehicle axis, the cardan shaft 5 has a greater length than the cardan shaft 4. The cardan shaft 5 includes a drive halfshaft 8 which is supported by the internal combustion engine 2 via a radial bearing unit 10 adjacent to a cardan joint 9. The radial bearing unit 10 includes a holder 11 which is mounted in a machine part 12, for connection to the internal combustion engine 2.

Referring now to FIG. 2, there is shown a partially sectional view of the radial bearing unit 10 according to the present invention. The radial bearing unit 10 has attachment surfaces 20a, 20b for support of the radial bearing unit 10 upon the internal combustion engine 2 and is secured by bolts (not shown). The holder 11, which is inserted in the machine part 12, includes a housing comprised of two housing portions 15, 16 (FIG. 4) and accommodates a rolling-contact bearing 17 for rotatably supporting the halfshaft 8. FIG. 2 shows the holder 11 in the installed or assembled state, whereby a pinned connection 46 may be provided to position the holder 11 relative to the machine part 12.

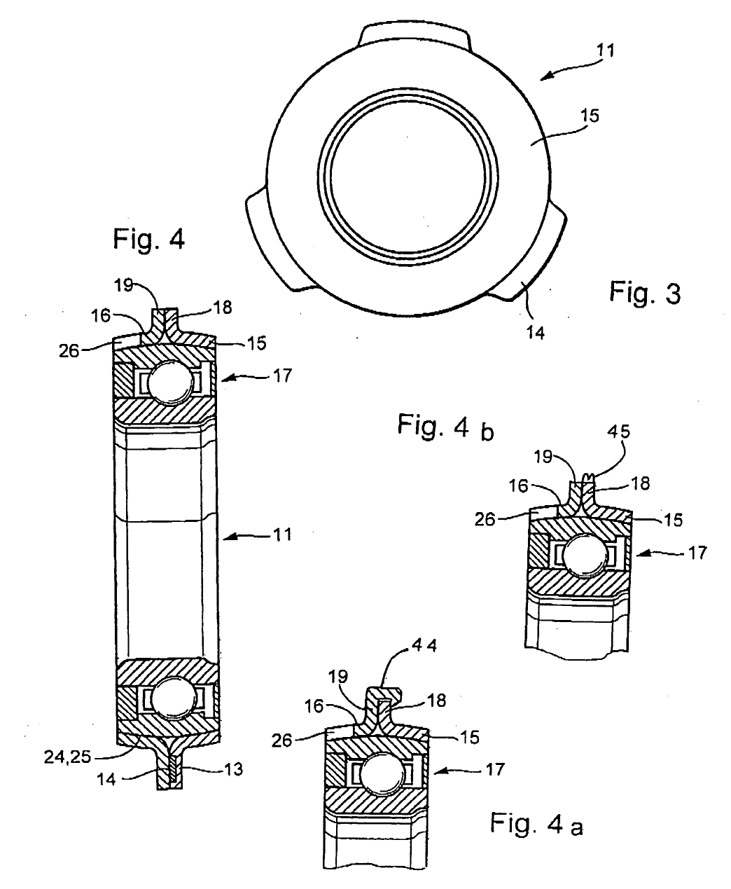

As shown in particular in FIG. 4, the housing portion 15 is formed with a flange 18 which is partially extended outwards by at least two radial tabs 14 (here by way of example three tabs 14 which are evenly spaced about the circumference of the flange 18), and the housing portion 16 is formed with a flange 19 which is partially extended by at least two radial tabs 13 (here by way of example also three tabs 13 which are evenly spaced about the circumference of the flange 19). FIG. 3 shows a front view of the housing portion 15 of the holder 11 with the three projecting tabs 14.

In order to enable installation of the holder 11 according to FIG. 1 into the machine part 12 of FIG. 2, the machine part 12 is formed with axial recesses 21 of a configuration that complements the tabs 13, 14 on the flanges 18, 19 of the holder 11. In the nonlimiting example of FIG. 2, three axial recesses 21 are provided in 120° spaced-apart relationship, whereby each of the axial recesses 21 extends from the end surface of the machine part 12 to a partial annular groove 22 formed in midsection of the machine part 12. Each annular groove 22 is hereby configured in the form of circular arc which is twice the dimension of the pertaining axial recess 21.

The holder 11 with accommodated rolling-contact bearing 17 is installed in the machine part as follows: The aligned and confronting radial tabs 13, 14 of the flanges 18, 19 of the holder 11 are first brought in alignment with the axial recesses 21 of the machine part 12. The holder 11 is then pushed axially into the machine part 12 until the tabs 13, 14 enter the pertaining annular grooves 22. Subsequently, the holder 11 is rotated in the direction of the arrow in FIG. 2 within each groove 22 until the movement is inhibited by the end stop 23. The rotation of the holder 11 in the grooves 22 is effected by a separate tool which can be inserted in indentations 26 formed on the end surface of the housing portion, as shown in FIG. 4, whereby only one indentation 26 is shown here. An example of a suitable tool includes a hook wrench for form-fitting engagement in the indentation 26. The rotation direction of the holder 11 coincides with the rotation direction of the drive halfshaft 8 so that the moment of momentum triggered by the halfshaft 8 during travel of the motor vehicle acts on the holder 11 or rolling-contact bearing 17 only in the direction of the end stop 23. Thus, a spontaneous loosening of the holder 11 in the machine part 12 is prevented.

As shown by way of example in FIG. 4a, the housing portions 15, 16 of the holder 11, after incorporation of the rolling-contact bearing 17, may be secured to one another by a clipped connection 44, thereby establishing a captivated pre-fabricated unitary structure.

Referring again to FIG. 4, it can be seen that the housing portions 15, 16 of the holder 11 form on the inside a spherical receptacle 24 which corresponds to a complementary curved outer surface area 25 of the rolling-contact bearing 17. The housing portions 15, 16 are hereby supported relative to one another via the flanges 18, 19, with an elastic disc 43 contained in the tabs 13 and biasing the tabs 13, 14, when installed.

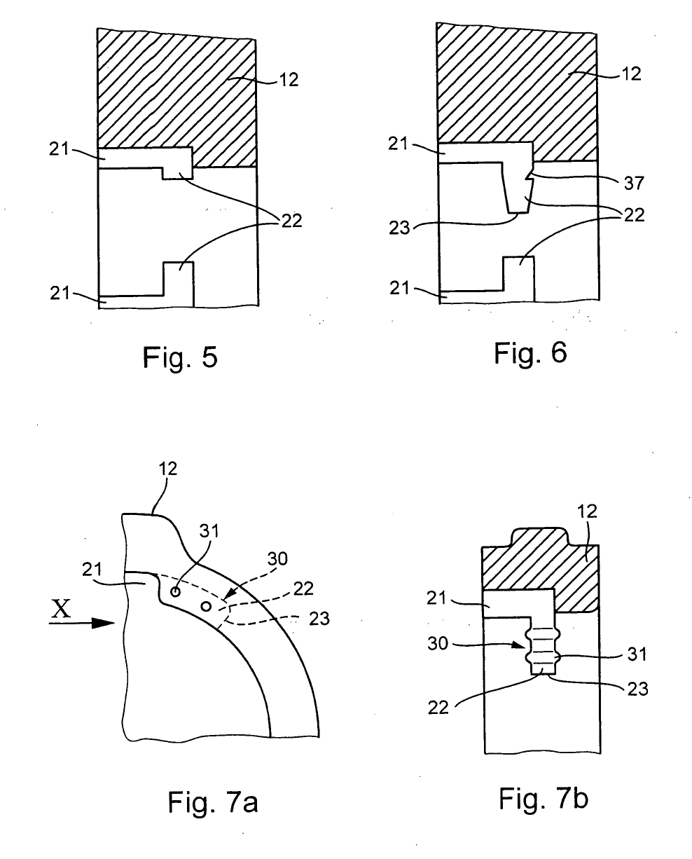

FIG. 5 shows in more detail the configuration of the inner groove 22 with pertaining axial recess 21 for insertion of securement of the tabs 13, 14 according to FIG. 4.

FIG. 4b shows one example of securing one of the housing portions 15, 16 (here housing portion 15) to the machine part 12 by means of an external thread 45.

Turning now to FIGS. 6 to 11, there are show various embodiments for securement of the tabs 13, 14 to the machine part 12.

In FIG. 6, the groove 22 tapers from the axial recess 21 continuously toward the end stop 23, thereby effectuating a desired self-locking mechanism of the tabs 13, 14 in the machine part 12, when the holder 11 is rotated. The self-locking action of the tabs 13, 14 can be further enhanced, when beveling the tabs 13, 14 on both sides in the area of the end surface to thereby realize a greater contact surface between the walls of the groove 22 and the tabs 13, 14. In addition, the tapered groove 22 may include undercuts 37 to ensure a form-fitting locking of the tabs 13, 14 in the groove 22.

FIGS. 7a, 7b illustrate one example of a securement 30 between the tabs 13, 14 and the machine part 12 in the area of the groove 22. The securing mechanism 30 establishes a releasable connection between the tabs 13, 14 and the machine part 12 and includes protuberances 31 jutting out laterally from the tabs 13, 13 for engagement in complementary half-round depressions 32 in the groove 22. As a result of the rounded protuberances 31 in conjunction with the complementary rounded depressions 32, the holder 11 and thus the tabs 13, 14 can be released from this end position.

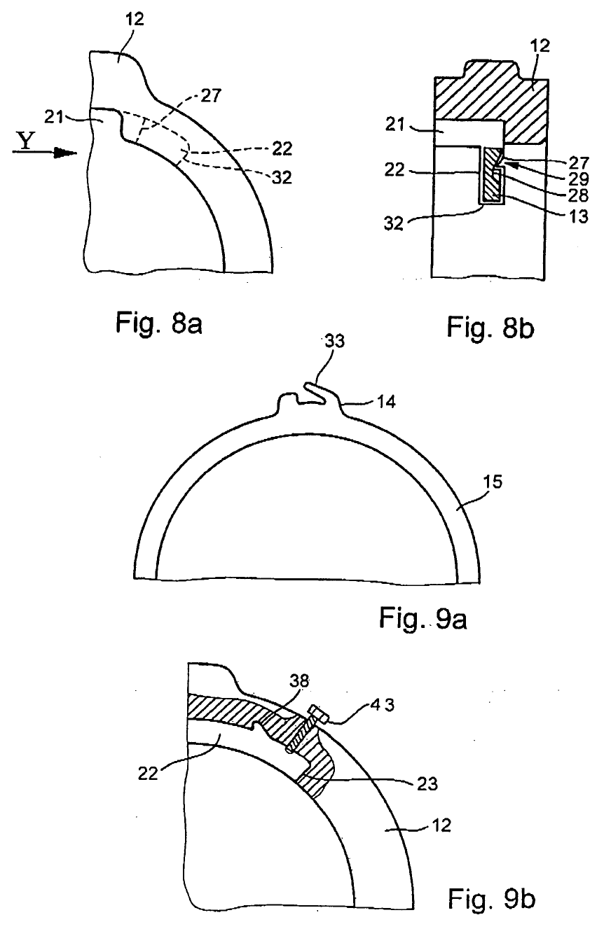

FIGS. 8a, 8b show another example of a securement 30 in which the machine part 12 includes a snap nose 27 in the form of a tooth which projects into the groove 22 and locks in a complementary recess 28 of the tab 14, when the tab 13 assumes the end position. The thus established snap-fit 29 realizes a permanent securement of the tabs 13, 14 in the machine part 12.

In FIGS. 9a, 9b, the tab 14 of the housing portion 15 is provided with a resiliently biased retaining lug 33 which extends radially outwards and locks into, e.g., an undercut or depression 38 of the machine part 12 in the area of the groove 22, when the holder 11 is installed in the machine part 12. As further shown, by way of example, in FIG. 9b, at least one fastening screw 43 is provided to extend radially in the machine part 12 into the area of the groove 22 for securing and disposition of the holder11.

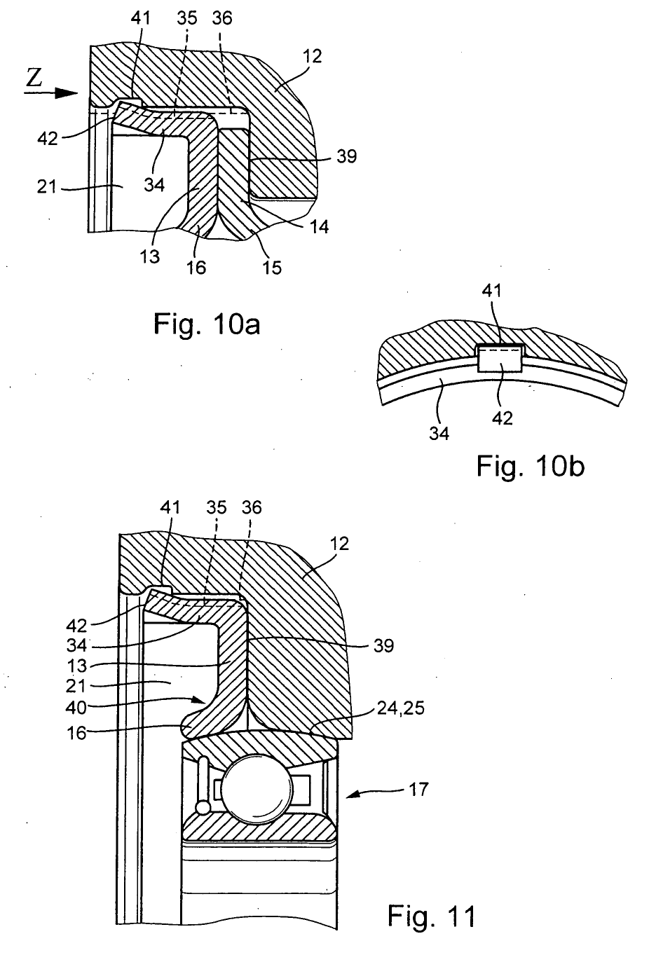

Another example of realizing a securement between the holder 11 and the machine part 12 is shown in FIGS. 10a, 10b and involves a threaded connection. The tab 13 of the housing portion 16 is hereby formed about the outer circumference in one piece with an arm 34 which extends at a right angle to the tab 13 and has an external thread 35 for meshing with an internal thread 36 of the machine part 12. During assembly, the holder 11 is first inserted axially into the machine part 12, and subsequently rotated until the holder 11 bears against an abutment 39 with the tab 14 of the housing portion 15. Suitably, the meshing threads 35, 36 have a large pitch so that the holder 11 reaches the end position after rotation about only a slight angle of rotation. In this way, there is no need for providing a continuous axial recess 21 in the machine part 12; Rather, the recess 21 may be formed of limited length, e.g. double the circular arc profile of the tabs 13, 14. The holder 11 can hereby be secured in the end position by providing the arm 34 on one end with a radially outwardly resilient snap nose 42 which snaps into a pocket 41 of the machine part 12.

FIG. 11 shows another embodiment of a radial bearing unit, generally designated by reference numeral 40 which is optimized to include only a minimum of components. Parts corresponding with those in FIG. 4 are denoted by identical reference numerals and not explained again. The description below will center on the differences between the embodiments. In this embodiment, the holder 11 has only housing portion 16 which together with the machine part 12 forms the spherical receptacle 24 for cooperation with the curved outer surface area 25 of the rolling-contact bearing 17 to thereby realize the self-adjustment of the rolling-contact bearing 17. In the end position of the holder 11, as depicted in FIG. 10a, the housing portion 16 is screwed into the machine part 12 via the meshed engagement between the external thread 35 of the arm 34 and the internal thread 36 of the machine part 12. The housing portion 16 is secured in the end position by the snap nose 32 which is disposed at one end of the arm 34 and form-fittingly engages the pocket 41 of the machine part 12.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A radial bearing unit for a driveshaft in a motor vehicle, comprising:
a holder intended for placement in a machine part and having a housing which is formed with a flange; and
a rolling-contact bearing received in the holder,
wherein the housing has at least two tabs extending radially in spaced-apart relationship from the flange for form-fitting engagement in the machine part, when the radial bearing unit is installed in the machine part.

2. The radial bearing of claim 1, wherein the housing of the holder is comprised of two housing portions which are so configured as to form together a spherical receptacle, with each of the housing portions having a said flange for mutual support of the housing portions, said rolling-contact bearing having a curved outer surface area for seating in the spherical receptacle.

3. The radial bearing of claim 1, wherein the housing of the holder and the machine part are so configured as to form together a spherical receptacle, said rolling-contact bearing having a curved outer surface area for seating in the spherical receptacle.

4. The radial bearing unit of claim 1, wherein the machine part is provided with axial recesses disposed in spaced-apart relationship and configured to complement the tabs, with each axial recess extending from an end surface of the machine part to an internal groove in the machine part for passage of the tabs and securement of the holder in the machine part.

5. The radial bearing unit of claim 4, wherein the holder is rotatable by a tool, when the tabs are located in the groove, until the tabs strike against an end stop of the groove in the machine part.

6. The radial bearing unit of claim 5, wherein the groove tapers from the axial recess in the direction to the end stop.

7. The radial bearing unit of claim 4, and further comprising securing means for form-fitting securement of the tabs in the groove of the machine part.

8. The radial bearing unit of claim 7, wherein the securing means includes a snap nose projecting rigidly from the machine part in the area of the groove for engagement in a complementary recess of the tabs, when the holder assumes its end position.

9. The radial bearing unit of claim 7, wherein the securing means includes a protuberance projecting from the tabs for form-fitting engagement in a lateral depression of the groove, when the holder assumes its end position.

10. The radial bearing unit of claim 7, wherein the securing means includes an elastically-biased retaining lug which extends in axial or radial direction for locked engagement in the groove of the machine part, when the holder assumes its end position.

11. The radial bearing unit of claim 7, wherein the securing means includes at least one fastening screw provided between the tabs and the machine part in the area of the groove for securing and disposition of the holder in the form of a bayonet coupling.

12. The radial bearing unit of claim 1, wherein the tabs have a thread for securement to the machine part.

13. The radial bearing unit of claim 3, wherein the housing has a thread for securement to the machine part.

14. The radial bearing unit of claim 4, wherein the tabs are each formed in one piece with an arm extending at a right angle and having an external thread for threaded engagement in an internal thread of the machine part.

15. The radial bearing unit of claim 14, wherein the arm has a free end formed with a radially-biased snap nose for form-fitting engagement in a pocket of the machine part, when the arm assumes its end position.

16. The radial bearing unit of claim 1, wherein the holder is positioned relative to the machine part by a pinned or screwed connection.

17. The radial bearing unit of claim 2, wherein the housing portions of the holder are joined together by a clipped connection.

18. A radial bearing unit for a driveshaft in a motor vehicle, in particular a halfshaft for connecting a transmission with a driven front wheel, said radial bearing unit comprising:
a holder having a housing comprised of two housing portions which are so configured as to form together a spherical receptacle, with each of the housing portions having a flange for mutual support of the housing portions; and
a rolling-contact bearing having a curved outer surface area for seating in the spherical receptacle,
wherein each of the housing portions has at least two radial tabs extending radially in spaced-apart relationship from the flanges for form-fitting engagement in a machine part, when the radial bearing unit is installed in the machine part.

19. A radial bearing unit for a driveshaft in a motor vehicle, in particular a halfshaft for connecting a transmission with a driven front wheel, said radial bearing unit comprising:
a rolling-contact bearing having a curved surface area;
a housing portion forming with a machine part a spherical receptacle for accommodating the rolling-contact bearing;
a radial flange in outer surrounding relationship to the housing portion and formed with at least two radial tabs for form-fitting securement to the machine part, when the radial bearing unit is installed in the machine part.

20. A method of mounting a radial bearing unit for a driveshaft to a machine part, wherein the radial bearing unit has a holder and a rolling-contact bearing fitted in the spherical receptacle, comprising the steps of:
aligning tabs of the holder with axial recesses of the machine part;
pushing the holder in axial direction until the tabs enter a groove of the machine part; and
turning the holder in a rotation direction relative to the machine part to secure the holder in the machine part, whereby the rotation direction of the holder corresponds to a rotation direction of the driveshaft.

21. The method of claim 20, wherein the turning step includes form-fittingly engaging a tool in a housing portion of the holder, and twisting the tool until the tabs of the holder impact an end stop of the groove in the machine part.
